(19) United States
(12) Patent Application Publication
(10) Pub. No.: US 2002/0072995 A1
(43) Pub. Date: Jun. 13, 2002

(54) Patent licensing process

(76) Inventor: Frank A. Smith, Dalton, MA (US)

Correspondence Address: OPPEDAHL AND LARSON LLP, P O BOX 5068, DILLON, CO, 80435-5068, US

(21) Appl. No.: 09/682,891

(22) Filed: Oct. 30, 2001

Related U.S. Application Data
(60) Provisional application No. 60/245,409, filed on Nov. 2, 2000.

(51) Int. Cl. G06F 17/60

(52) U.S. Cl. 705/27

(57) ABSTRACT

The present application provides a method for patent licensing which comprises providing a web site listing a plurality of patents available for unilateral license together with copies of at least one unilateral license for associated with at least one of the listed patents.

### CROSS REFERENCE TO RELATED APPLICATIONS

This application claims the benefit of U.S. Provisional Application Serial No. 60/245,409, filed Nov. 2, 2000, which is incorporated herein by reference.

### BACKGROUND OF INVENTION

The present invention relates generally to the field of patent licensing, and more specifically to the field of patent licensing using the Internet.

The market for intellectual property rights, and more specifically patent rights, is often extremely inefficient because licensors of intellectual property typically lack both detailed information about the value of such intellectual property to potential licensees, and information about the activities of patent infringers. For example, process patent owners often lack knowledge about infringement where the infringing process may only be observed in a competitor's manufacturing facility. This problem is even more difficult when the facility is located abroad and the licensor is seeking royalties from importers of goods made abroad by a process patented in the United States.

When faced with the options of obtaining an opinion of counsel regarding a particular patent or contacting the holder of a potentially adverse patent, many companies first choose to obtain an opinion even in cases where they believe the patent holder may be willing to license because the problematic patent has relatively little value to the patent holder's business. This economic inefficiency is caused by the potential licensee's (perhaps rational) fear that if it asks for a license, the patentee may either refuse or may investigate aggressively and charge the potential licensee a royalty which is very near the value of the license to the licensee, which may be a much greater sum than the business cost of granting the license suffered by the licensor.

In many cases, the cost of obtaining such a legal opinion may in fact be higher than the licensor's business cost of granting a license, but the license transaction may never occur due to the above described market inefficiency. The missing revenue caused by this inefficiency in the patent licensing market causes corporations to see their patents as less valuable than they otherwise might because patent assets are only factored into companies' balance sheets when they are sold or licensed.

Recently, several corporations and Internet Web Sites have been created in an attempt to make patent licensing more efficient. These companies and sites include Yet.2com, pl-x.com, patentauction.com, PATEX, patentCafe, buypatents.com, IBM's pink dot program and numerous others. Unfortunately, none of these sites offers the ability to fully complete a license transaction immediately on-line without fear of the licensor investigating the licensee's need for the license and charging a high price based on the licensee's need rather than the licensor's cost. As a result, these sites have relied on “carrot” rather than “stick” licensing, and have thus far had limited commercial success.

Therefore, there is a need for a system to enable a patent licensing market where potential patent licensors would offer patent licenses based on business cost to the licensor, and where licensees would be free to consider purchasing a license without identifying themselves and risking entering a negotiation under immediate threat of litigation.

### SUMMARY OF INVENTION

The present application provides a method for patent licensing which comprises providing a web site listing a plurality of patents available for unilateral license together with copies of at least one unilateral license associated with at least one of the listed patents.

### BRIEF DESCRIPTION OF DRAWINGS

FIGS. 1(a)-(b) depict a block diagram describing the function of a system for patent licensing.

FIG. 2 depicts an introductory web page in a system of web pages for patent licensing.

FIG. 3 depicts an instruction page in a system of web pages for patent licensing.

FIG. 4 depicts a contact recording form in a system of web pages for patent licensing.

FIG. 5 depicts a sample search results page that might be generated upon use of the search function depicted in FIG. 3.

FIGS. 6(a) 6(j) depict a sample unilateral license of the type that might be available upon clicking button 160 depicted in FIG. 2.

### DETAILED DESCRIPTION

The text of the present application may be better understood with reference to the following definitions.

For purposes of the present application, the term “web” describes the World Wide Web or any other quasi-public system for electronically delivering text and images which may be displayed via electronic means.

For purposes of the present application, the term “web page” refers to an electronically transmitted image, optionally containing text, which is accessible via the web.

For purposes of the present application, the term “web site” refers to a plurality of interconnected web pages wherein one web page may be addressed from another web page which forms part of the web site.

For purposes of the present application, the team “sign-in procedure” refers to any mechanism whereby the viewer of the web site is required to supply information relating to the identity of the viewer.

For the purposes the present application, the term “unilateral” license means any license that can be accepted by the licensee to create a legally binding contract or option to contract without further action on the part of the licensor. For the purposes of this agreement, the terms license and licensee shall have their normal meaning, but also be inclusive of assignment and assignee, respectively.

For purposes of the present application, the term “indicate interest” in the context of a licensee viewing a particular patent on a web page could include providing a system that requires the potential licensee to computer mouse-click on a part of a web page associated with a particular patent, type a field associated with the particular patent, type the number of the particular patent, perform a search to identify set of patents or take any other action that could indicate to the provider of the web page that the potential licensee was interested in a particular patent listed on the web page.

For the purposes of the present application, the term “providing” in the context of a copy of the unilateral license agreement means displaying the agreement on a web page, making the agreement available as a compute file for download or some other manner of making the text of the agreement available for viewing by the potential licensee.

For the purposes of the present application, the term “exclusive” unilateral license form refers to a form wherein the licensor promises to the licensee that it will not grant similar rights to a different licensee. The term “exclusive unilateral license” shall also include an assignment.

For the purposes of the present application, the term “royalty” or “royalties” may include an up-front payment or a running royalty. If desired, the payment could be made by a different party on behalf of the licensee, and, if desired, could be made to a party other than the licensor. In any case, such payments pursuant to the license agreements will be considered to be “royalties.” For purposes of the present application the term “associated with” in the context of a license being associated with a particular license form means that that application may be licensed by executing that particular license form.

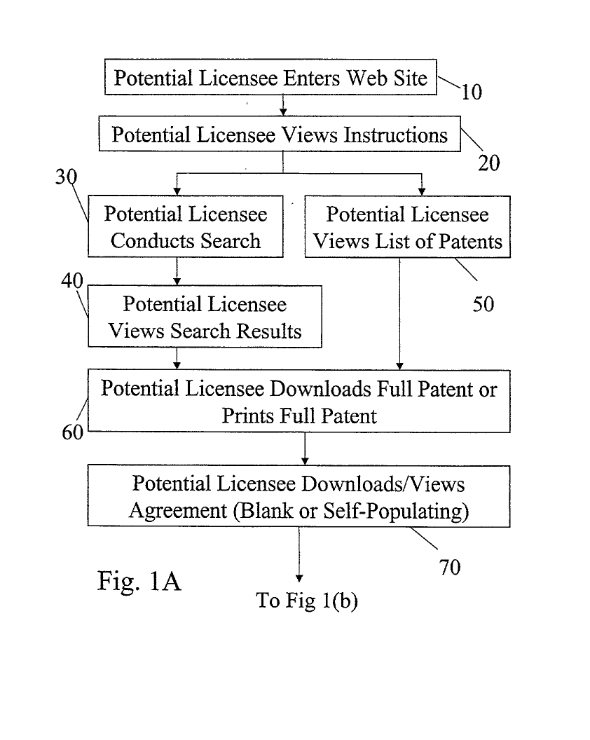

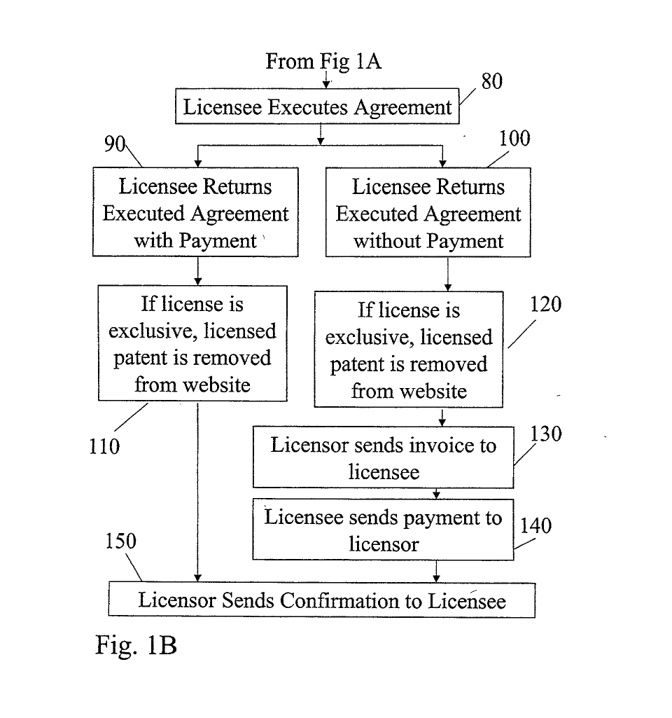

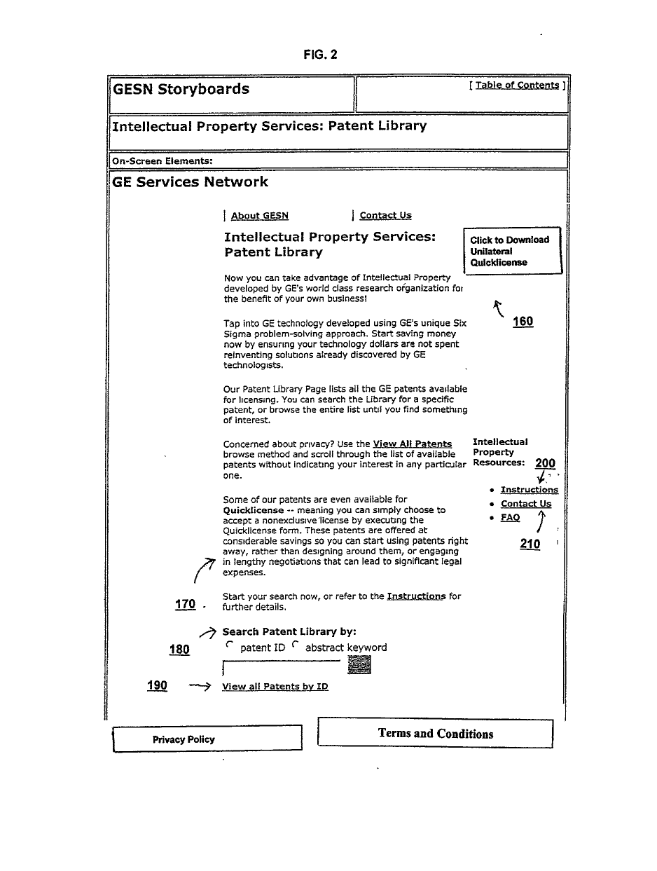

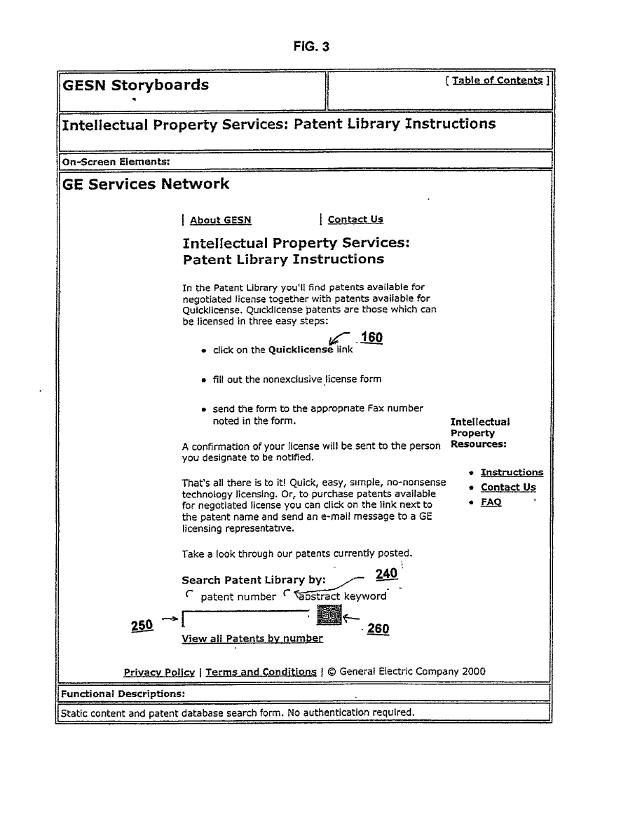

Referring to FIGS. 1(a)-1(b), the present invention provides a web site for patent licensing wherein potential licensees can complete unilateral license transactions without action required on the part of the licensor. According to one preferred embodiment of the invention described by FIGS. 1(a)-1(b), the potential licensee first enters the web site 10 by entering a URL address (e.g., an http:\\www.______. com address) via an internet browser program or accesses the web site by activating a link (e.g., a button on a web page activated by a mouse click) from a different web site. Once the potential licensee enters the web site, they will typically view an introductory web page such as that depicted in FIG. 2.

Next in the process, the potential licensee will optionally view instructions for using the web site 20. The instructions may be included in the introductory web page or in a separate downloadable file or web page.

Next, the potential licensee may conduct a search 30 or may choose to simply view the list of available patents 50. The search 30 may be any sort of search based, for example, on patent number, title, subject matter classification code, assignee, inventor, abstract, full text, any combination thereof, or any other searching criteria. The search 30 may also be based on the terms of the license available for a particular patent. For instance, a search could be directed toward the (possible) subset of listed patents that are available for unilateral nonexclusive license or unilateral exclusive license, or both. FIG. 3 depicts an example of such a search web page.

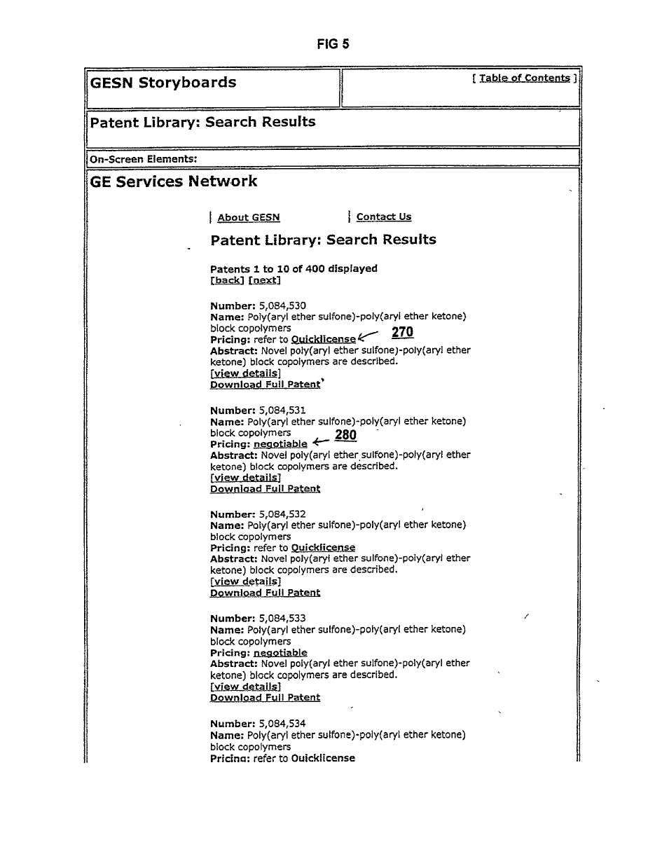

If the potential licensee conducts a search 30, they will subsequently view the list of results 40. The results may be made available in summary form by patent number, title, or abstract, or any other criteria. The results 40 may be displayed in a separate web page or may be transmitted by other means (e.g., e-mail, downloadable file, etc.) FIG. 5 displays a sample search results page that might display such results.

In a preferred embodiment of the invention, a potential licensee would have the option to also view and/or download the full text of any listed patent 60 or any patent identified in a search.

In the next step according to FIG. 1(a), the potential licensee would view the unilateral license agreement 70. The unilateral license agreement could be provided, for example, as a separate web page or as a downloadable file. In preferred embodiments of the invention, all downloadable documents would be provided in a universally accessible free electronic format such as Adobe's ACROBAT PDF format.

The potential licensee could view and execute the agreement by a variety of methods. Most simply, the potential licensee could view the text of the agreement on a web page, print the web page, fill out the blank in the contract form, sign the agreement and mail it back to the licensor or send it to the licensor via facsimile. It would also be possible for the text of the agreement to be a downloadable document. In another embodiment, a web page could prompt the potential licensee to fill in several of the required pieces of information to self populate a draft contract with information such as the potential licensee's name, address and the desired patent, and any other desired information. The patent number could be automatically filled in if the system were created such that a potential licensee would have to indicate interest in a particular patent prior to, or simultaneously with, generating the self-populated license form.

After viewing and filling out the agreement, the system may or may not provide an option for the potential licensee to print the form.

Next, the system provides a method for the potential licensee to execute the agreement 80 in a legally binding manner without any intervention required or possible on the part of the licensor. This may be accomplished by the licensee printing out the license form, filling out the blank (if any), signing and sending back the license by mail, courier, or facsimile. Alternatively, the contract could be executed by electronic means such as digital signature. Mechanisms for digital signature have been widely described in public literature and some examples are described in U.S. Pat. Nos. 6,097,813, 6,088,798, 6,088,454, 6,085,321, 6,049,610, 5,956,404, 5,805,703, and 5,717,759, which are hereby incorporated by reference.

The contract may provide for the licensee to return the executed contract together with payment 90 or may provide for the licensee to return the executed contract without an attached payment 100. In either case, if the contract is an exclusive unilateral license, a mechanism will be provided for indicating that no further licenses are available after execution of the first exclusive license 110, 120. For example, when the licensor receives an executed copy of an exclusive license agreement, the licensor may enter this information into a computer to change the web site to no longer display the licensed patent.

In the case where payment is received together with the executed license agreement, the licensor may opt to send a confirmation to the licensee 150. In cases where payment is not required immediately, the licensor may send an invoice to the licensee 130, have the licensee send payment to the licensor 140, and follow-up with a confirmation 150.

### PROPHETIC EXAMPLES

### Example 1

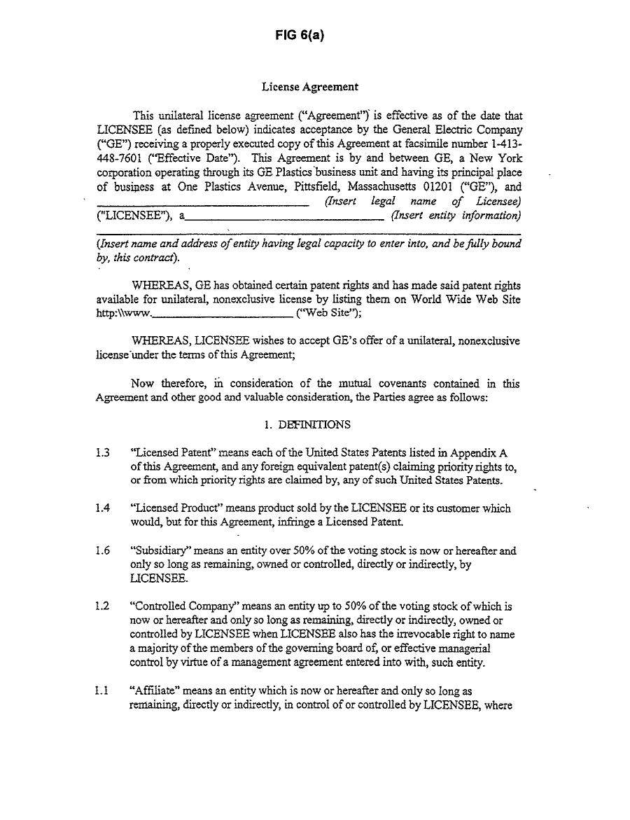

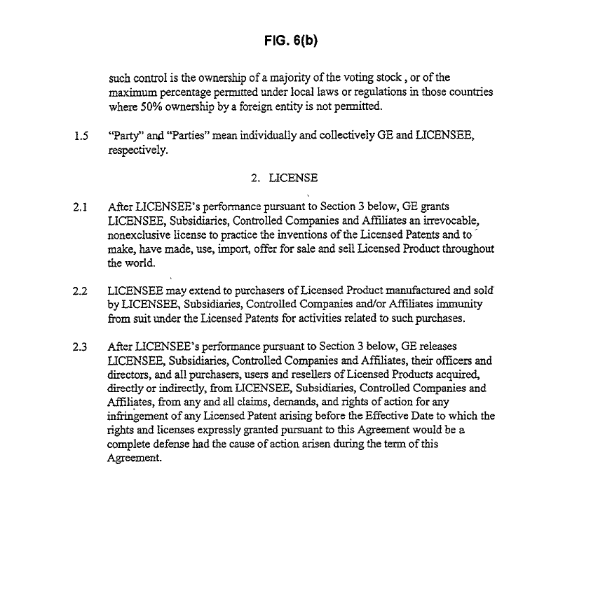

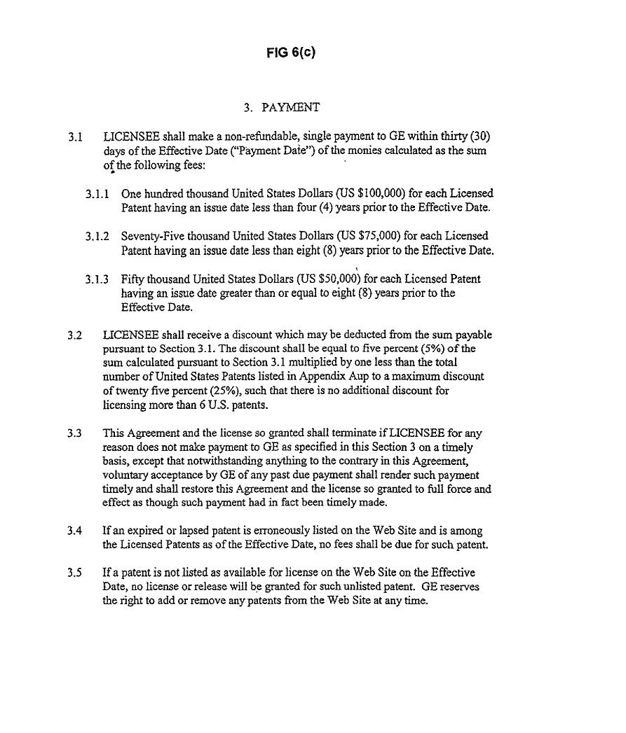

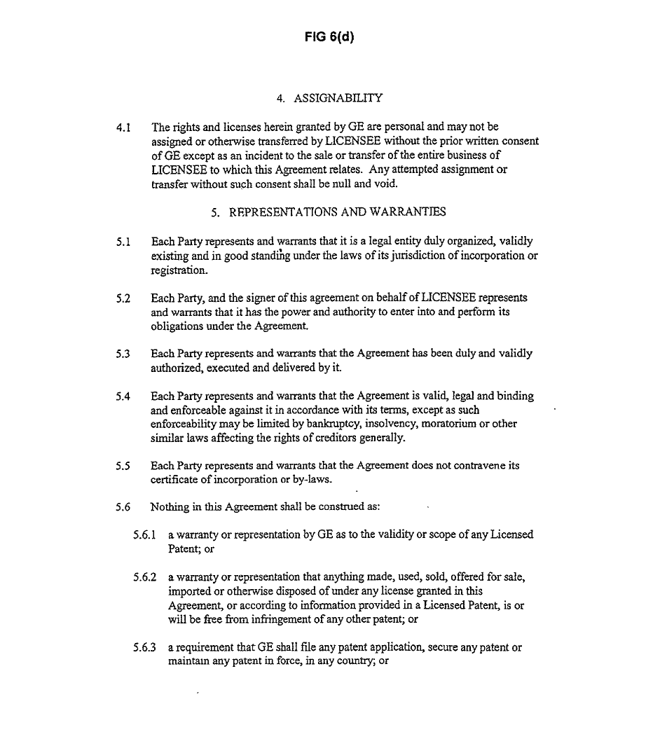

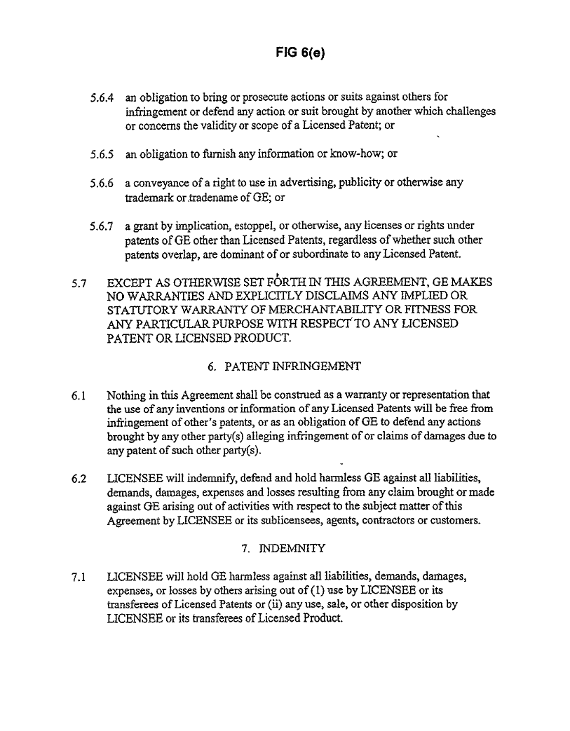

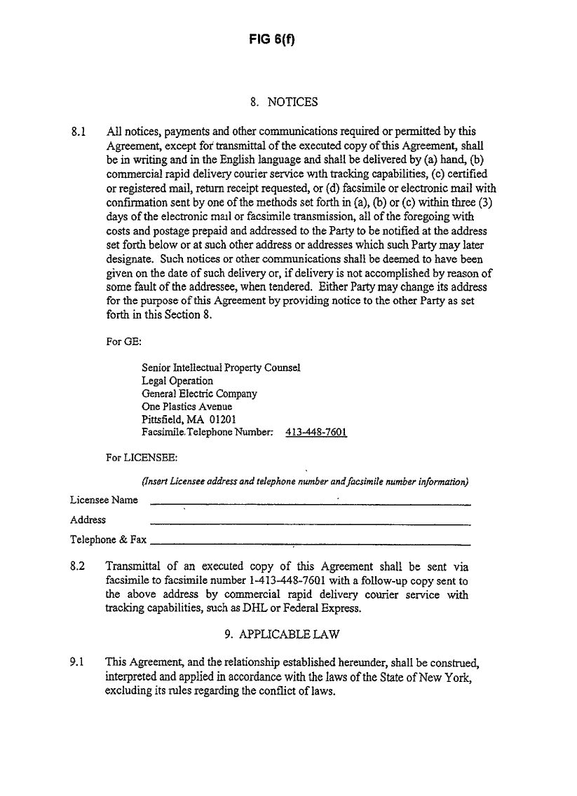

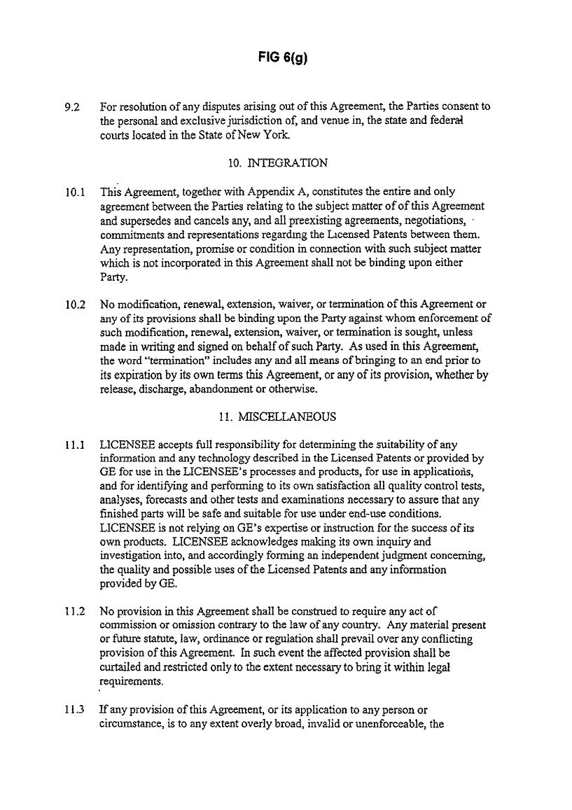

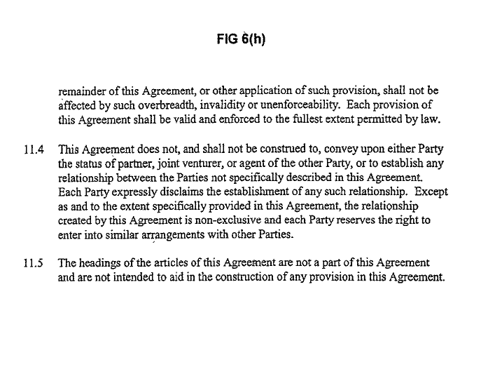

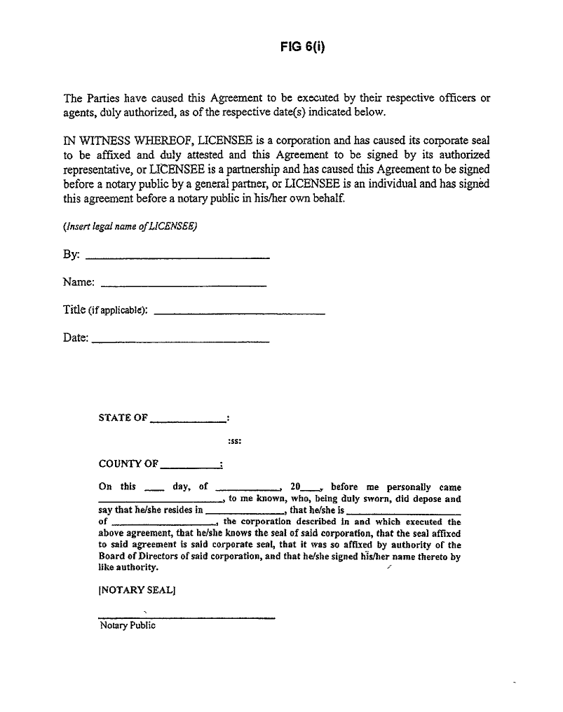

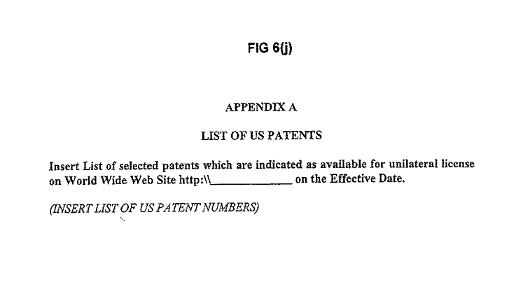

A potential licensee uses Microsoft's EXPLORER web browser program to enter the introductory web page depicted in FIG. 2 by typing in the appropriate URL (e.g., “http:\\www.______.com”) address corresponding to the web page. The potential licensee reads the page and clicks on the instruction button 200, which brings up the instruction web page depicted in FIG. 3. The potential licensee then uses a computer mouse to select the radio button for “abstract keyword” 240 at the bottom of FIG. 3, types the word “copolymer” in the blank text field 250 below the radio button and uses the mouse to click on the “Go” button 260. This brings up the list of patents in FIG. 5. The potential licensee clicks on the “Quicklicense” button 270 which downloads an Adobe ACROBAT PDF file corresponding to the license shown in FIGS. 6(a)-6(j). The potential licensee prints the form, fills in the missing information and mails the form to the licensor. The licensor sends an invoice to the licensee. The licensor pays royalties to the licensor, and the licensor sends a confirmation to the licensee.

### Example 2

The potential licensee repeats the process described in Example 1 and selects the “Quicklicense” button 270 next to a particular listed patent, which goes to a web page displaying a series of questions corresponding to the missing information referred to in the contract shown in FIGS. 6(a)-6(j), with the exception of the web site address and the list of licensed patents. The potential licensee fills in answers to these questions and clicks a “generate agreement” button on said web page. Next, another web page is displayed which has an agreement similar to that depicted in FIGS. 6(a)-6(j), with the exception that all the blanks are filled in. The potential licensee prints the complete agreement, signs it and mails it to the licensor together with a check for the amount due. The licensor sends a confirmation.

### Example 3

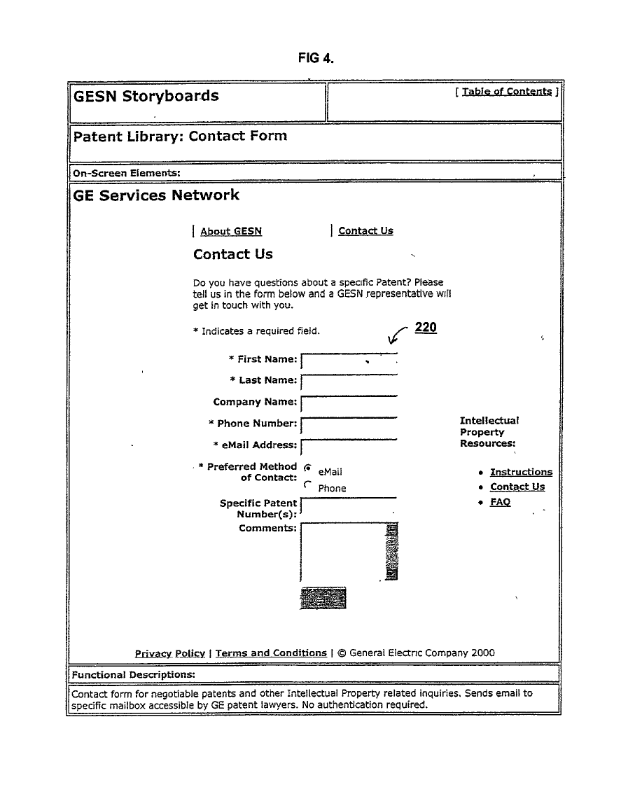

The potential licensee repeats the process described in Example 2 and selects the “Negotiable” button 280 next to a particular patent which brings up the contract recording form shown in FIG. 4. The potential licensee fills out the required information 220, received a communication from the licensor and negotiates a license.

### Example 4

The potential licensee repeats the process described in Example 1 and identifies a patent available for Quicklicense (i.e., unilateral license) that interests the licensor. The potential licensee uses the web browser to return to the web page depicted in FIG. 2. The potential licensee clicks the unilateral license download button 160 to download the contract shown in FIGS. 6(a)-6(j). the potential licensee fills in the missing information, executes the contract, and mails it to the licensor. The licensor receives the contract and sends an invoice to the potential licensee. The potential licensee sends the required fee to the licensor. The licensor sends a letter to the licensee confirming receipt of the payment.

### Example 5.

A potential licensee identifies a patent belonging to the licensor through other means which concerns the potential licensee. The potential licensee views the web page depicted in FIG. 2 and clicks on the view all patents button 190 which brings up all patents available for license in an ordered list. The potential licensee identifies the patent that concerns him/her as available for unilateral license and executes a license as described in Example 4.

### Example 6.

The potential license repeats the process described in Example 1 and brings up a page similar to that shown in FIG. 5 with the exception that various patents are associated with “exclusive quick license A,” “nonexclusive quick license B” and “negotiable.” Also, some patents are associated with more than one of the above categories of licenses. For a patent associated with both “exclusive quick license A,” “nonexclusive quick license B” and “negotiable” the potential licensee uses their web browser to return to a web page similar to that shown in FIG. 2 with the exception that several download buttons 160 are available for all the above listed licenses. The viewer downloads exclusive quick license A and executes it as described in the previous examples. When the licensor receives the executed agreement, the licensor changes the web site to no longer list the patent selected by the licensee.

Although the present invention has been described in considerable detail with reference to certain preferred versions thereof, other versions are possible. Therefore, the spirit and scope of the appended claims should not be limited to the description of the preferred versions contained herein.

1. A method for patent licensing which comprises providing a web site listing a plurality of patents available for unilateral license together with copies of at least one unilateral license form associated with at least one listed patent.

2. The method according to claim 1, wherein the web site does not require a sign-in procedure on the part of any potential licensee.

3. The method according to claim 2, which further comprises providing a copy of the unilateral license which can be viewed by any potential licensee without a potential licensee having to indicate interest in a particular listed patent.

4. The method according to claim 3, which further comprises providing a list of patents available for unilateral license which can be viewed by any potential licensee without a potential licensee having to indicate interest in a particular listed patent.

5. The method according to claim 2, which further comprises sending an acknowledgement form to a licensee after said licensee indicates acceptance of a unilateral license.

6. The method according to claim 4, which further comprises sending an invoice to a licensee after said licensee indicates acceptance of a unilateral license.

7. The method according to claim 1, wherein at least one unilateral license form associated with a listed patent is an exclusive unilateral license form, which method further comprises indicating on the web site that the listed patent is no longer available for licensing if a licensee has indicated acceptance of an exclusive unilateral license for said listed patent.

8. The method according to claim 1, wherein a first listed patent is associated a first unilateral license and a second listed patent is associated with a second unilateral license, which second unilateral license differs from the first unilateral license.

9. The method according to claim 1, wherein the unilateral license form lists different initial royalty payments that are dependent on the age of the listed patent.

10.The method according to claim 1, wherein a royalty can be calculated according to the unilateral license form.

11. The method according to claim 1, wherein a royalty is listed on the web site and the unilateral license form refers to the royalty listed on the web site.

12. The method according to claim 1, wherein a listed patent is associated with a plurality of unilateral licenses.

13. The method according to claim 12, wherein the listed patent is associated with at least one exclusive unilateral license.
